(19) United States
(12) Patent Application Publication
(10) Pub. No.: US 2026/0187948 A1
(43) Pub. Date: Jul. 2, 2026

(54) INFORMATION PROCESSING DEVICE, INFORMATION PROCESSING METHOD, AND COMPUTER-READABLE NON-TRANSITORY STORAGE MEDIUM

(71) Applicant: SONY GROUP CORPORATION, TOKYO (JP)

(72) Inventor: YUKI FURITSU, TOKYO (JP)

(21) Appl. No.: 18/833,965

(22) PCT Filed: Jan. 26, 2023
(86) PCT No.: PCT/JP2023/002427

§ 371 Date: Jul. 29, 2024

(30) Foreign Application Priority Data
Feb. 7, 2022 (JP) 2022-016971

(51) Int. Cl. G06T 19/20; G06F 16/583; G06T 7/70; G06T 15/20; G06T 17/00

(52) U.S. Cl. CPC G06T 19/20; G06F 16/5854; G06T 7/70; G06T 15/20; G06T 17/00; G06T 2219/2004; G06T 2219/2021

(57) ABSTRACT

An information processing device (10) includes an occlusion determination unit (11), a model database (MD), and a missing completion processing unit (15). The occlusion determination unit (11) determines whether there is an occlusion relationship between a subject included in a captured image and a surrounding object existing around the subject. The model database (MD) defines a shape of a registered object. The missing completion processing unit (15) completes a shape of the subject in a portion hidden behind the surrounding object due to the occlusion relationship, by using the shape of the registered object.

### FIELD

The present invention relates to an information processing device, an information processing method, and a computer-readable non-transitory storage medium.

### BACKGROUND

A technology of seamlessly connecting the real world and the virtual world and enabling mutual interaction is coming true. The technology includes approaches toward reproducing the real world in the virtual world using a free viewpoint video technology and implementing, in the virtual world, interaction with an object in the real world.

In the free viewpoint video technology, using a plurality of captured images having different image capturing positions (hereinafter, these captured images are collectively referred to as “multi-viewpoint images”; the “multi-viewpoint images” are a generic term for a plurality of captured images obtained by capturing the real world from various viewpoints), a three-dimensional model of the real world is generated. By rendering the three-dimensional model based on viewpoint information, a video (free viewpoint video) of a flexibly selected viewpoint is generated. In a case of virtually moving or deleting a real world object (surrounding object) around the subject, the surrounding object is moved or deleted on the three-dimensional model.

### CITATION LIST

### Patent Literature

Patent Literature 1: JP 2020-135525 A

### Non Patent Literature

Non Patent Literature 1: TOMASI, et al. Cornell Univ., Shape and motion from image streams under orthography: A factorization approach.

Non Patent Literature 2: Riegler, et al. Stable View Synthesis, Intel Labs

Non Patent Literature 3: J. Yu, et al. Univ. of Illinois, Free-Form Image Inpainting with Gated Convolution

### SUMMARY

### Technical Problem

By moving or deleting a surrounding object, a portion hidden behind the surrounding object (occlusion region) is exposed. For example, when the legs of the chair have been hidden behind the table, the legs of the chair are exposed by movement of the table. When performing an interaction such as virtual movement of furniture, it is necessary to construct an appropriate three-dimensional model even for a portion that is physically invisible by being hidden by an object in front. However, in a case where a three-dimensional model is generated from multi-viewpoint images, the three-dimensional model is not generated for a portion (occluded region) not captured in the multi-viewpoint images. Therefore, in cases where the surrounding object is moved or deleted, an appropriate image is not displayed in the occluded region.

In view of this, the present disclosure proposes an information processing device, an information processing method, and a computer-readable non-transitory storage medium capable of appropriately completing the shape of a portion hidden behind a surrounding object.

### Solution to Problem

According to the present disclosure, an information processing device is provided that comprises: an occlusion determination unit that determines presence or absence of an occlusion relationship between a subject included in a captured image and a surrounding object existing around the subject; a model database that defines a shape of a registered object; and a missing completion processing unit that completes a shape of the subject at a portion hidden behind the surrounding object due to the occlusion relationship, by using the shape of the registered object. According to the present disclosure, an information processing method in which an information process of the information processing device is executed by a computer, and a computer-readable non-transitory storage medium that stores a program for causing the computer to execute the information process of the information processing device, are provided.

### BRIEF DESCRIPTION OF DRAWINGS

FIG. 1 is a diagram illustrating a configuration example of an information processing system.

FIG. 2 is a diagram of a method of estimating a relationship between objects.

FIG. 3 is a diagram illustrating an example of a rule database.

FIG. 4 is a flowchart of relationship estimation processing using a rule database.

FIG. 5 is a diagram illustrating an example of a model database.

FIG. 6 is a diagram illustrating a construction example of a model database.

FIG. 7 is a diagram illustrating a subject search example using a CAD database not including data related to a coexisting object.

FIG. 8 is a diagram illustrating a subject search example using a CAD database not including data related to a coexisting object.

FIG. 9 is a diagram illustrating a search example of a subject using a model database.

FIG. 10 is a diagram illustrating a search example of a subject using a model database.

FIG. 11 is a diagram illustrating a search example of a subject using a model database.

FIG. 12 is a diagram illustrating a hardware configuration example of the first calculation device.

### DESCRIPTION OF EMBODIMENTS

Embodiments of the present disclosure will be described below in detail with reference to the drawings. In each of the following embodiments, the same parts are denoted by the same reference symbols, and a repetitive description thereof will be omitted.

Note that the description will be given in the following order.
[1. Configuration of information processing system]
[2. Estimation of relationship between objects]
[3. Search processing using model database]
[4. Hardware configuration example]
[5. Effects]

### 1. Configuration of Information Processing System

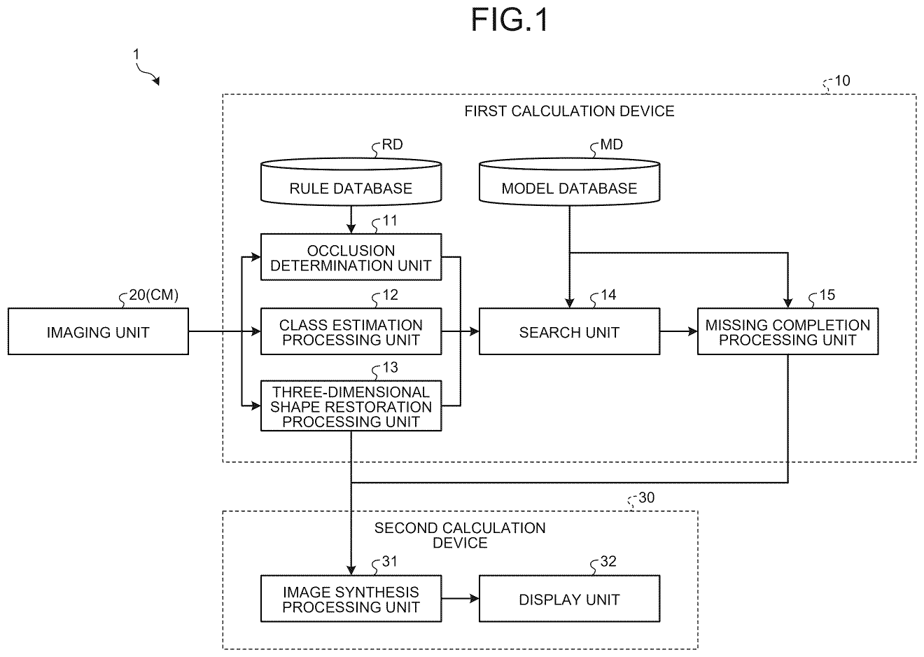

FIG. 1 is a diagram illustrating a configuration example of an information processing system 1.

The information processing system 1 is a system that captures an entire real world and reproduces the real world from a free viewpoint. The information processing system 1 generates a three-dimensional model of the real world using the multi-viewpoint images acquired from an imaging unit 20. The information processing system 1 performs rendering of the three-dimensional model based on viewpoint information, thereby generating a video (free viewpoint video) of a flexibly selected viewpoint.

For example, the information processing system 1 includes a first calculation device 10, the imaging unit 20, and a second calculation device 30. The imaging unit 20 includes one or more cameras CM. The imaging unit 20 supplies a plurality of captured images captured from various viewpoints as multi-viewpoint images. The first calculation device 10 generates a three-dimensional model of the real world based on the multi-viewpoint images. The second calculation device 30 performs rendering of the three-dimensional model based on the viewpoint information, and thereby generates a free viewpoint video.

The first calculation device 10 is a high-performance information processing device such as a server. The second calculation device 30 is a portable or wearable information terminal such as a smartphone or AR glasses. Data transmission between the imaging unit 20 and the first calculation device 10 is performed by wired communication or wireless communication, and data transmission inside the first calculation device 10 is entirely performed by wired communication. Data transmission between the first calculation device 10 and the second calculation device 30 is performed by wired communication or wireless communication, and data transmission inside the second calculation device 30 is performed by wired communication in order to achieve low latency.

The development of virtual reality (VR)/augmented reality (AR) technologies has led to implementation of a technology of seamlessly connecting the real world and the virtual world and enabling mutual interaction. For example, the AR+ mode of Pokémon GO allows a character to virtually appear on a plane detected in the real world, achieving an interaction with the virtual object. In addition, there has also been disclosed an application or the like of easily trying room makeover by arranging pieces of virtual furniture, electrical appliances, or the like to blend in to a room in the real world.

In such a current technology (known technique 1), the real world is recognized in some form, and a virtual object is appropriately superimposed on a video of the real world viewed through a camera. Therefore, in order to experience the video connecting the real world and the virtual world, it is necessary to appropriately move the camera to a position that the user wants to view.

On the other hand, there is a conceivable approach of completely reproducing the real world in the virtual world and implementing interaction with an object in the virtual world. In this case, it is necessary to synthesize the video to be viewed by the user from the reproduced virtual world. A technique (known technique 2) of generating a three-dimensional model from multi-viewpoint images obtained by capturing the real world and synthesizing a realistic image using the generated three-dimensional model has been disclosed in a recent academic conference.

With the method of the known technique 2, the user can experience a virtual world that reproduces the real world from a flexibly selected position. However, it is necessary to overcome difficulties in order to express the interaction with the object in the virtual space. For example, in a case where it is desired to move or delete an object existing in the real world from the video to be experienced by the user, it is possible, with the known technique 1, to cope with the case by starting interaction by the user in the real world. On the other hand, in the known technique 2, it is possible to cope with the situation by virtually moving or deleting the corresponding object in the virtual world that has reproduced the real world, but it is necessary to consider an occlusion relationship between individual objects. The occlusion relationship represents a relationship in which a part of a rear object is occluded by a front object.

As described above, in a case of performing an interaction to virtually move real pieces of furniture in a virtual space, there is a need to construct an appropriate three-dimensional model for a portion that is hidden behind the piece of furniture and is not physically visible in the multi-viewpoint images.

Examples of a method of performing image synthesis from a three-dimensional model that has reproduced a certain space include a classical method based on geometry (Non Patent Literature 1) and a new method using deep learning (Non Patent Literature 2). In each method, it is possible to synthesize images when the space is viewed from a flexibly selected viewpoint position/direction based on the shape and texture of the three-dimensional model. The realism of the synthesis result in such a method greatly depends on the accuracy of the three-dimensional model. Therefore, it is important to minimize the error between the shape in the three-dimensional model and the actual shape.

Furthermore, in such an image synthesis method, when interaction such as deletion of a surrounding object is performed on the three-dimensional model, the result of the interaction is directly reflected in the image synthesis result. However, in the three-dimensional model restored from the multi-viewpoint images, when a surrounding object is deleted, a correct shape cannot be expressed in a region that is initially occluded by the surrounding object and then becomes visible after the deletion. In a case where such an inaccurate three-dimensional model is used, image synthesis fails in a region that includes an image of a surrounding object. In order to solve this problem, the following two methods are conceivable.

(I) A method of completing only a region that includes an image of a surrounding object in an image synthesis result by using surrounding pixel information or information obtained by learning in advance (Non Patent Literature 3).

(II) A method of obtaining an appropriate three-dimensional model from multi-viewpoint images even in a case where a subject is occluded in the three-dimensional model (Patent Literature 1).

In the method of Non Patent Literature 3, an image that is realistic and consistent with the surroundings is synthesized by Gated Convolution in an image region having missing pixels. Gated Convolution is a mechanism that enables a convolution operation to exclude a missing image region in a convolution neural network (CNN). By training such a CNN with several millions of images, image missing completion is performed. It is conceivable to simply apply this method to a problem that the image synthesis result is deteriorated due to a change in the occlusion state. Specifically, the image synthesis results before and after the deletion of the surrounding object are compared with each other, and a portion having a change is defined as a missing region in which the pixel is missing. By using the CNN using the Gated Convolution for the missing region, there is a possibility that a natural image can be synthesized even after the deletion of the subject.

However, in consideration of a case where the interaction between the virtual space and the user, it is necessary to perform missing completion on the three-dimensional model. The above method performs natural completion of only the appearance on the image, and thus, cannot perform missing completion of the three-dimensional model to be the basis of image synthesis. This causes a deviation between the virtual space viewed by the user and the virtual space in which the interaction is actually performed.

In the method of Patent Literature 1, even in a case where the subject is occluded in one of the captured images constituting the multi-viewpoint images, a three-dimensional model is created by the Shape-From-Silhouette (SFS) method by combining a plurality of masks. Specifically, a subject region and a foreground object region occluding the subject region are extracted from each captured image constituting the multi-viewpoint images, and the three-dimensional model is generated by integrating the individual regions.

However, in the method of Patent Literature 1, the occluded region is defined as a region that is visible from one of the captured images. When performing an interaction with an object in the virtual space, there is a case where a region that has not been visible in any captured image when the virtual space is constructed becomes visible afterward. In addition, there is a problem that the missing due to the occlusion is determined only on the captured image. In order to generate a three-dimensional model for a region that is not visible from any captured image, it is necessary to determine the missing due to occlusion in units of space.

Furthermore, the method of capturing multi-viewpoint images is limited in the technique of Patent Literature 1. In a case where a three-dimensional model is obtained using the Shape-From-Silhouette (SFS) method, it is necessary to pre-arrange a camera so as to surround a subject and perform calibration, but such an image capturing method requires expertise.

The present invention has been made in view of the above problems. The information processing system 1 of the present disclosure performs an occlusion determination for each subject included in the captured image using a relationship with the surrounding objects existing in the neighborhood. Subsequently, the information processing system 1 performs missing completion for each occluded subject. With this method, even when a part of the subject is occluded in the real world, it is possible to obtain a three-dimensional model suitable for image synthesis from multi-viewpoint images. In addition, unlike Non Patent Literature 3, missing completion of the occluded object is directly performed on the three-dimensional model, making it possible to maintain the consistency between the image synthesis result and the virtual space in which interaction is performed. Details will be described below.

### <First Calculation Device>

The first calculation device 10 includes an occlusion determination unit 11, a class estimation processing unit 12, a three-dimensional shape restoration processing unit 13, a search unit 14, a missing completion processing unit 15, a rule database RD, and a model database MD.

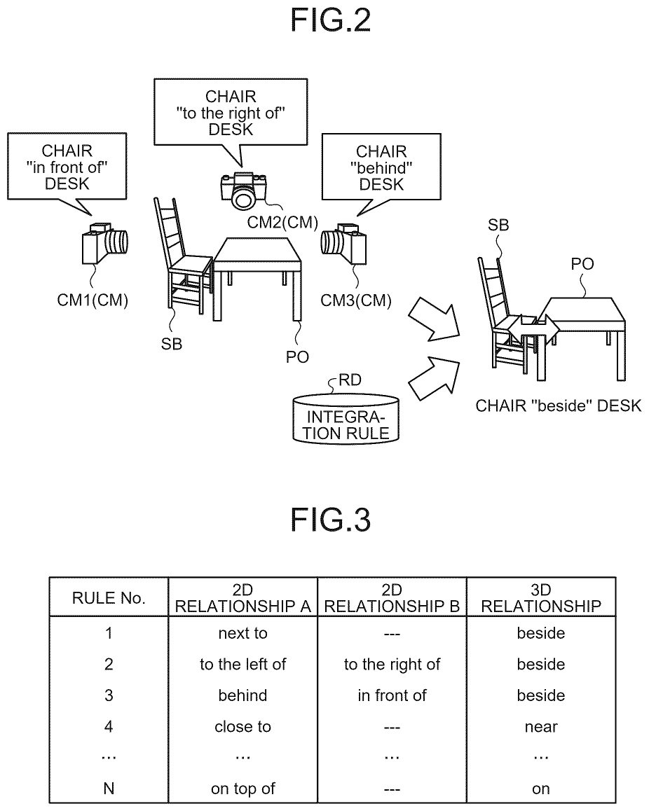

Using an object detection technology, the occlusion determination unit 11 extracts individual objects existing in the real world from the multi-viewpoint images acquired from the imaging unit 20. The occlusion determination unit 11 specifies each of the extracted objects as a subject SB (refer to FIG. 2), and determines the presence or absence of an occlusion relationship between the subject SB and a surrounding objects PO (refer to FIG. 2) for each subject SB. The surrounding object PO represents an object in the real world existing around the subject SB.

The occlusion relationship represents a relationship in which a part of a rear object is occluded by a front object. In a case where a part of the rear object is not visible because of the front object, it is determined that there is an occlusion relationship between the front object and the rear object. The occlusion determination unit 11 examines the presence or absence of an occlusion relationship for each captured image according to the rule defined in the rule database RD. In a case where there is an occlusion relationship in any of the captured images, the occlusion determination unit 11 determines that there is an occlusion relationship as a whole.

The class estimation processing unit 12 estimates a class of each object extracted from the multi-viewpoint images using an object detection technology. The class represents a category of an object, such as a chair, a desk, and a bed.

The three-dimensional shape restoration processing unit 13 generates a three-dimensional model of the real world from the multi-viewpoint images using a method such as the Shape-From-Silhouette (SFS) method. By rendering the three-dimensional model based on the viewpoint information, the three-dimensional shape of the real world is restored. In a case where an object is virtually moved or erased by the user's operation, the three-dimensional shape restoration processing unit 13 generates a new three-dimensional model in which the object has been moved or erased. With this processing, the object is moved or erased on the three-dimensional model.

The search unit 14 searches for a registered object corresponding to the subject SB in the model database MD. The model database MD stores CAD data of a plurality of registered objects. The search unit 14 checks whether the features of the subject SB extracted from the multi-viewpoint images matches the model database MD, and detects a registered object corresponding to the subject SB.

The missing completion processing unit 15 extracts the shape of the registered object corresponding to the subject SB from the model database MD. By using the shape of the registered object extracted from the model database MD, the missing completion processing unit 15 completes the shape of the subject SB in a portion (occlusion region) hidden behind the surrounding object PO due to the occlusion relationship. For example, in a case where the surrounding object PO has been moved or deleted, the missing completion processing unit 15 completes the data of the occluded region in which the missing occurs due to the movement or deletion of the surrounding object PO by using the data of the registered object extracted from the model database MD. With this processing, a three-dimensional model with no missing is generated.

### <Second Calculation Device>

The second calculation device 30 includes an image synthesis processing unit 31 and a display unit 32. The image synthesis processing unit 31 performs rendering of the three-dimensional model based on the viewpoint of the user and outputs the three-dimensional model to the display unit 32. With this processing, the three-dimensional shape in the real world is restored in the virtual space. Examples of the display unit 32 include a liquid crystal display (LCD) and an organic light emitting diode (OLED). When implementing AR, the image synthesis processing unit 31 superimposes an image obtained by the rendering on an image of the external world seen through the display unit 32.

### 2. Estimation of Relationship Between objects

FIG. 2 is a diagram of a method of estimating a relationship between objects.

The example of FIG. 2 assumes a scene in which the subject SB and the surrounding object PO are arranged at the center of the room. The subject SB is a chair, and the class of the subject SB is “CHAIR”. The surrounding object PO is a desk, and a class of the surrounding object PO is “DESK”. The imaging unit 20 includes a first camera CM1, a second camera CM2, and a third camera CM3. The first camera CM1, the second camera CM2, and the third camera CM3 capture images of the indoor space from the left side, the back side, and the right side of the room, respectively.

The occlusion determination unit 11 estimates the presence or absence of an occlusion relationship for each captured image based on the relationship (relative positional relationship) between the subject SB and the surrounding object PO. For example, for the captured image (first captured image) of the first camera CM1, the occlusion determination unit 11 estimates a relationship that the subject SB is in front of the surrounding object PO. For the captured image (second captured image) of the second camera CM2, the occlusion determination unit 11 estimates a relationship that the subject SB is arranged to the right of the surrounding object PO. For the captured image (third captured image) of the third camera CM3, the occlusion determination unit 11 estimates the relationship that the subject SB is behind the surrounding object PO.

As described above, even when an identical scene is captured, the estimated relationship between the subject SB and the surrounding object PO varies depending on the viewpoint (image capturing direction) of the camera CM. This is because only a two-dimensional relationship can be obtained from a captured image being a two-dimensional image. To handle this, the occlusion determination unit 11 consolidates the two-dimensional relationship presented in the first captured image, the two-dimensional relationship presented in the second captured image, and the two-dimensional relationship presented in the third captured image, thereby estimating the three-dimensional relationship independent of the viewpoint. The relationship estimation processing is performed using the rule database RD.

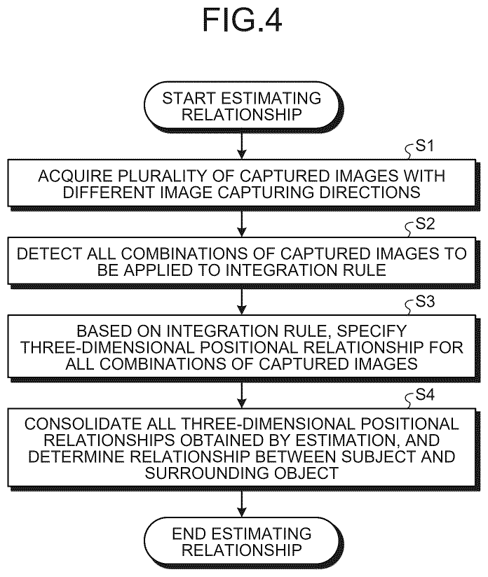

FIG. 3 is a diagram illustrating an example of the rule database RD. FIG. 4 is a flow of relationship estimation processing using the rule database RD.

The rule database RD defines an integration rule for integrating a two-dimensional positional relationship (“2D relationship A”) presented in a first image and a two-dimensional positional relationship (“2D relationship B”) presented in a second image into a three-dimensional positional relationship (“3D relationship”).

The occlusion determination unit 11 acquires a plurality of captured images having different imaging directions from the imaging unit 20 (step S1). The occlusion determination unit 11 detects all combinations of the captured images corresponding to the first image and the second image from the plurality of captured images having different image capturing directions (step S2). The occlusion determination unit 11 applies the integration rule to each combination of the captured images and estimates the three-dimensional positional relationship for each combination of the captured images (step S3). The occlusion determination unit 11 consolidates all the three-dimensional positional relationships obtained by the estimation (step S4). The occlusion determination unit 11 determines the occlusion relationship based on the consolidated information of the positional relationship obtained by the consolidation.

For example, the rule database RD defines terms indicating two-dimensional relationships, such as “next to”, “to the left of”, “to the right of”, “behind”, “in front of”, “close to”, and “on top of”. The rule database RD defines terms indicating three-dimensional relationships, such as “beside”, “near”, and “on”.

For example, in a case where both the two-dimensional relationship estimated from the first image and the two-dimensional relationship estimated from the second image are “next to”, “to the left of”, “to the right of”, “behind”, or “in front of”, the term “beside” is determined as a term indicating the three-dimensional relationship.

In the example of FIG. 2, “CHAIR “in front of” DESK” is estimated from the first captured image. “CHAIR ”to the right of “DESK” is estimated from the second captured image. “CHAIR “Behind” DESK” is estimated from the third captured image.

The combinations of the captured images that can be the first image and the second image include: (i) a combination of the first captured image and the second captured image; (ii) a combination of the first captured image and the third captured image; and (iii) a combination of the second captured image and the third captured image. The three-dimensional positional relationship estimated from the combinations of (i), (ii) and (iii) is “CHAIR “beside” DESK”. Accordingly, the occlusion determination unit 11 acquires a three-dimensional relationship “CHAIR “beside” DESK” as the consolidated information.

When there is a variation in a plurality of three-dimensional positional relationships obtained by estimation, a positional relationship is determined by majority decision. For example, the occlusion determination unit 11 takes a majority decision on all the three-dimensional positional relationships obtained by the estimation, and acquires a three-dimensional positional relationship obtained by the majority decision as the consolidated information.

### 3. Search Processing using Model Database

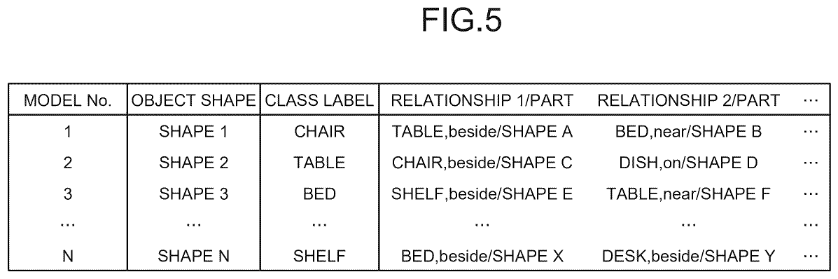

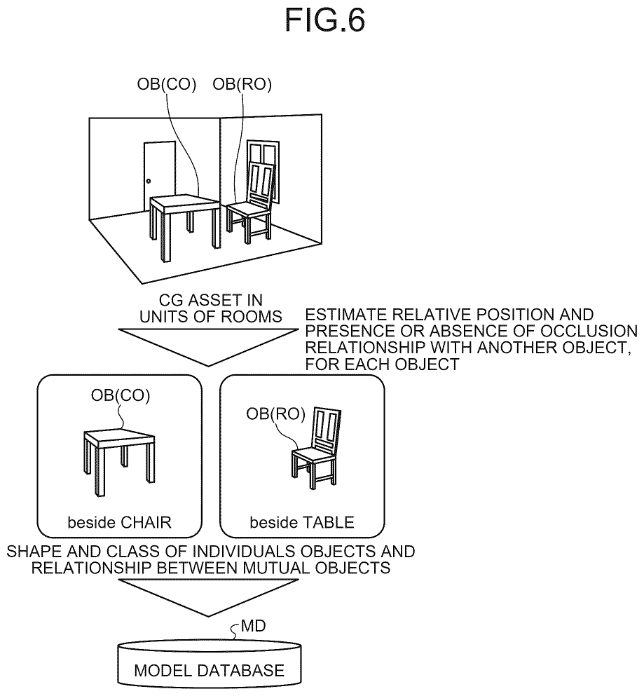

FIG. 5 is a diagram illustrating an example of the model database MD. FIG. 6 is a diagram illustrating a construction example of the model database MD.

The model database MD defines information for each registered object RO, such as a shape of the registered object RO, a class of the registered object RO, and a positional relationship between the registered object RO and a coexisting object CO. The coexisting object CO means an object OB that can coexist around the registered object RO. Examples of the registered object RO and the coexisting object CO include a chair and a desk, or a bed and a blanket. The search unit 14 checks whether the shape of the subject SB, the class of the subject SB, and the positional relationship between the subject SB and the surrounding object PO match the model database MD, and detects the registered object RO corresponding to the subject SB.

In the example of FIG. 5, the model database MD has a plurality of registered objects RO identified by Model Numbers. For example, the registered object RO having the Model Number 1 has a three-dimensional shape of “shape 1” and a class of “CHAIR”. “TABLE”, “BED”, . . . are registered as the classes of the coexisting object CO. The positional relationship with the coexisting object CO indicated by “TABLE is “beside”, and the positional relationship with the coexisting object CO indicated by “BED” is “near”. Similarly, information such as a shape, a class, and a positional relationship with the coexisting object CO is defined for the registered object RO having the Model Number 2 or more.

Construction of the model database MD uses a CG asset in units of rooms as illustrated in FIG. 6, for example. The CG asset includes CAD models of a plurality of objects OB. First, for each object OB in the CG asset, a relationship with a coexisting object CO existing around the object OB is determined from three-dimensional distances and directions between the models. Next, the position of the part (occluded part) of the object OB occluded by the coexisting object CO is acquired.

The model database MD defines a part of the registered object RO that can be located behind the coexisting object CO as an occluded part. In the presence of a plurality of coexisting objects CO for one registered object RO, the model database MD defines an occluded part for each of the coexisting objects CO.

In the example of FIG. 5, a first coexisting object CO represented by “TABLE” and a second coexisting object CO represented by “BED” are defined for the registered object RO (class: “CHAIR”) with Model Number 1. The occluded part (for example, a leg of the chair, or a seat surface and a leg of the chair) defined by “Shape A” is registered for the first coexisting object CO, and the occluded part (for example, a leg of the chair) represented by “Shape B” is registered for the second coexisting object CO.

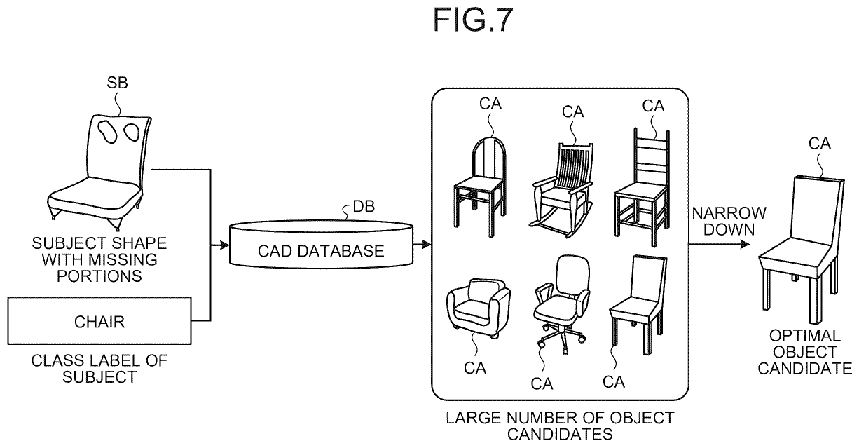

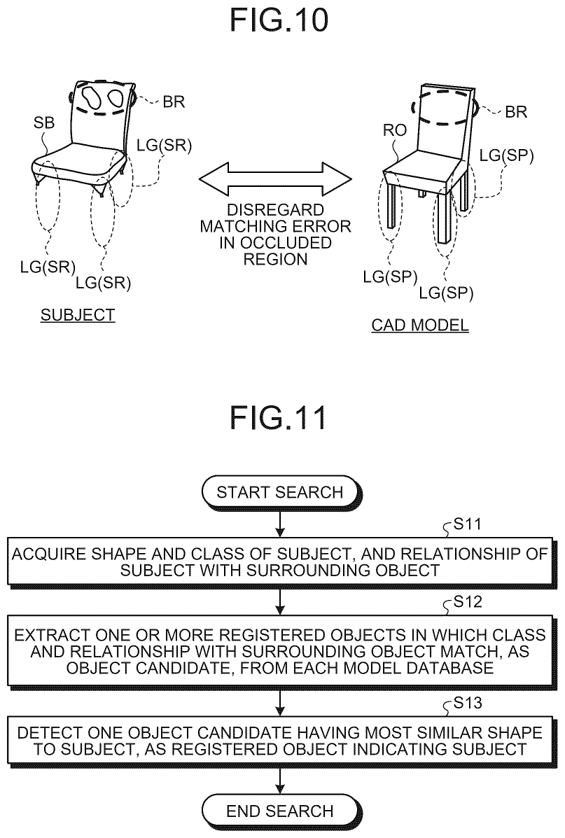

FIGS. 7 to 11 are diagrams illustrating search examples of the subject SB. For example, the subject SB is a chair, and a table exists as the surrounding object PO around the subject SB.

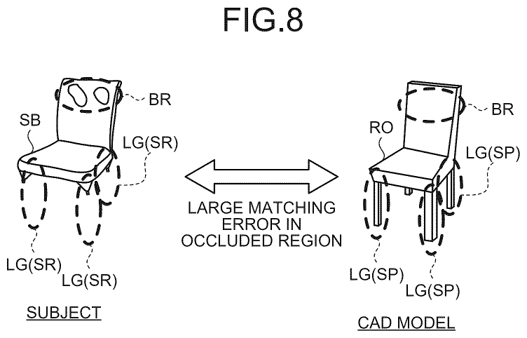

FIGS. 7 and 8 are diagrams illustrating a search example using the CAD database DB that does not include data related to the coexisting object CO. The CAD database DB defines only the shape of the registered object RO and the class of the registered object RO. The search unit 14 checks whether the class and shape of the subject SB matches the CAD database DB, and detects the registered object RO corresponding to the subject SB.

In the example of FIG. 8, legs LG of the subject SB (chair) are portions (occluded regions SR) hidden by the surrounding object PO (table) and invisible. Although the model of the entire shape of the chair is registered in the CAD database DB, the shape of the subject SB known from the captured image is not the entire shape of the chair but the shape of the seat surface and a backrest BR of the chair excluding the legs LG.

The search unit 14 extracts each of a plurality of registered objects RO whose class matches the subject SB as an object candidate CA. The search unit 14 detects the object candidate CA having the most similar shape to the subject SB among the extracted object candidates CA, as the registered object RO corresponding to the subject SB. In this method, the object candidate CA is narrowed down based on only the class. Therefore, sufficient narrowing is not performed. In addition, since the matching error in the occluded region SR is large, the subject SB is not specified with high accuracy.

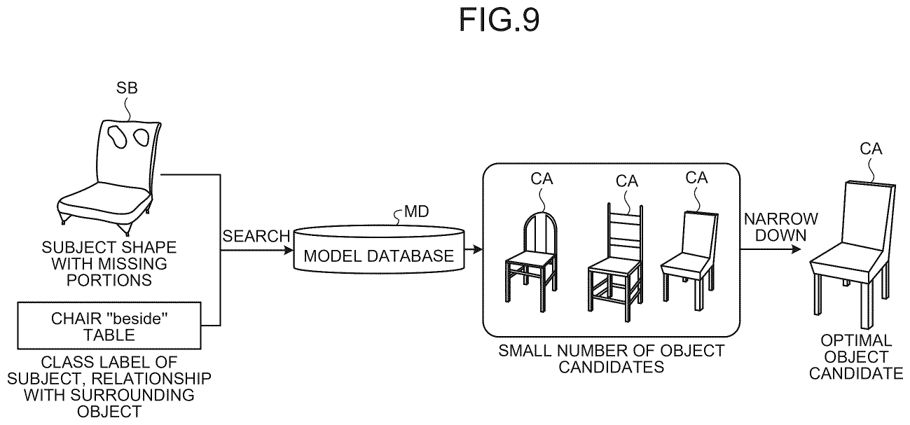

FIGS. 9 to 11 are diagrams illustrating search examples using the model database MD. The model database MD has defined the shape of the registered object RO, the class of the registered object RO, the positional relationship between the registered object RO and the coexisting object CO, and the occluded part of the registered object RO. The search unit 14 checks whether the shape of the subject SB, the class of the subject SB, and the positional relationship between the subject SB and the surrounding object PO match the model database MD, and detects the registered object RO corresponding to the subject SB. Hereinafter, a specific description will be given based on the flow of FIG. 11.

The search unit 14 acquires information regarding the shape of the subject SB, the class of the subject SB, and the positional relationship between the subject SB and the surrounding object PO from the three-dimensional shape restoration processing unit 13, the class estimation processing unit 12, and the occlusion determination unit 11, respectively (step S11).

The search unit 14 extracts one or more registered objects RO in which the class of the registered object RO and the positional relationship between the registered object RO and the coexisting object CO match the class of the subject SB and the positional relationship between the subject SB and the surrounding object PO, individually as the object candidates CA (step S12). The search unit 14 detects the object candidate CA having the most similar shape to the subject SB among the one or more extracted object candidates CA, as the registered object RO corresponding to the subject SB (step S13).

In a similarity judgment, the search unit 14 performs judgment of the similarity between the subject SB and the object candidate CA by giving a higher weight to the feature of the object candidate CA of the portion excluding the occluded part, compared with the occluded part. For example, the search unit 14 check whether the shape of the subject SB matches the shape of the object candidate CA of the portion excluding the occluded part (that is, disregarding matching errors in the occluded region SR), thereby determining the similarity between the subject SB and the object candidate CA.

In this method, the object candidates CA are narrowed down based on the class and a positional relationship between the subject SB and the surrounding object PO. Therefore, sufficient narrowing is performed. In addition, since the matching error in the occluded region SR is disregarded, the subject SB is specified with high accuracy.

For example, in the example of FIG. 8, the difference between the subject SB and the registered object RO is the presence or absence of the leg LG and the presence or absence of the recess in the upper portion of the backrest BR. The legs LG of the subject SB are substantially invisible from the captured image. The presence or absence of the legs LG is a large difference. In the search example using the CAD database DB, the presence or absence of the leg LG contributes to the similarity judgment, lowering the accuracy of the similarity judgment. In contrast, in the search example using the model database MD, since the presence or absence of the leg LG is substantially or completely disregarded in the similarity judgment, the difference is only in the recess of the backrest BR. Therefore, the similarity between the subject SB and the registered object RO is checked with high accuracy.

### 4. Hardware Configuration Example

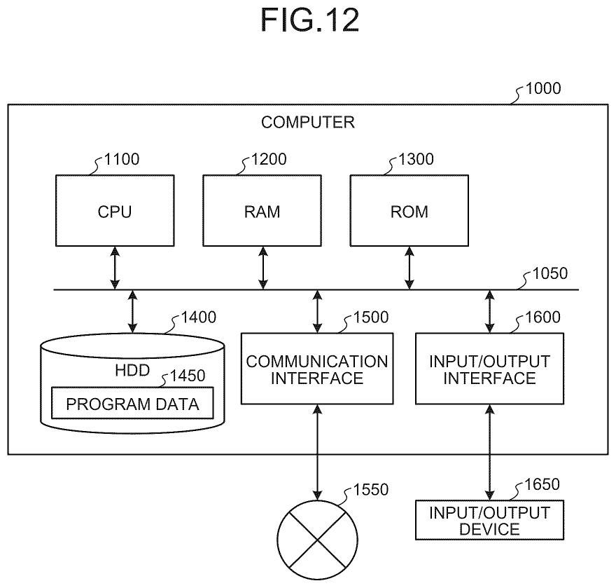

FIG. 12 is a diagram illustrating a hardware configuration example of the first calculation device 10.

The information processing of the first calculation device 10 is implemented by a computer 1000, for example. The computer 1000 includes a central processing unit (CPU) 1100, random access memory (RAM) 1200, read only memory (ROM) 1300, a hard disk drive (HDD) 1400, a communication interface 1500, and an input/output interface 1600. Individual components of the computer 1000 are interconnected by a bus 1050.

The CPU 1100 operates based on a program (program data 1450) stored in the ROM 1300 or the HDD 1400 so as to control each of components. For example, the CPU 1100 develops a program stored in the ROM 1300 or the HDD 1400 onto the RAM 1200, and executes processing corresponding to various programs.

The ROM 1300 stores a boot program such as a basic input output system (BIOS) executed by the CPU 1100 when the computer 1000 starts up, a program dependent on hardware of the computer 1000, or the like.

The HDD 1400 is a non-transitory computer-readable recording medium that performs non-transitory recording of a program executed by the CPU 1100, data used by the program, or the like. Specifically, the HDD 1400 is a recording medium that records an information processing program according to the embodiment, which is an example of the program data 1450.

The communication interface 1500 is an interface for connecting the computer 1000 to an external network 1550 (for example, the Internet). For example, the CPU 1100 receives data from other devices or transmits data generated by the CPU 1100 to other devices via the communication interface 1500.

The input/output interface 1600 is an interface for connecting an input/output device 1650 with the computer 1000. For example, the CPU 1100 receives data from an input device such as a keyboard or a mouse via the input/output interface 1600. In addition, the CPU 1100 transmits data to an output device such as a display device, a speaker, or a printer via the input/output interface 1600. Furthermore, the input/output interface 1600 may function as a media interface for reading a program or the like recorded on a predetermined recording medium. Examples of the media include optical recording media such as a digital versatile disc (DVD) or a phase change rewritable disk (PD), a magneto-optical recording medium such as a magneto-optical disk (MO), a tape medium, a magnetic recording medium, and semiconductor memory.

For example, when the computer 1000 functions as the first calculation device 10 according to the embodiment, the CPU 1100 of the computer 1000 executes the information processing program loaded on the RAM 1200 so as to implement the functions of the above-described individual portions. In addition, the HDD 1400 stores an information processing program, various models, and various data according to the present disclosure. While the CPU 1100 executes program data 1450 read from the HDD 1400, the CPU 1100 may acquire these programs from another device via the external network 1550, as another example.

### 5. Effects

The first calculation device 10 includes the occlusion determination unit 11, the model database MD, and the missing completion processing unit 15. The occlusion determination unit 11 determines whether there is an occlusion relationship between the subject SB included in the captured image and the surrounding object PO existing around the subject SB. The model database MD defines the shape of the registered object. The missing completion processing unit 15 completes the shape of the subject SB in the portion hidden behind the surrounding object PO by the shape of the registered object RO due to the occlusion relationship. With the information processing method of the present disclosure, the processing of the first calculation device 10 is executed by the computer 1000. The computer-readable non-transitory storage medium of the present disclosure stores a program that causes the computer 1000 to implement processing of the first calculation device 10.

With this configuration, the shape of the subject SB in the portion hidden behind the surrounding object PO is appropriately completed by the shape of the registered object. Therefore, even when the surrounding object is moved or deleted, the entire shape of the subject is reproduced with high accuracy.

The first calculation device 10 includes the search unit 14. The search unit 14 searches for the registered object RO corresponding to the subject SB. The model database MD defines: the class of the registered object RO; and the positional relationship between the registered object RO and the coexisting object CO that can coexist around the registered object RO. The search unit 14 checks whether the shape of the subject SB, the class of the subject SB, and the positional relationship between the subject SB and the surrounding object PO match the model database MD, and detects the registered object RO corresponding to the subject SB.

With this configuration, the registered object RO corresponding to the subject SB is detected with high accuracy based on the shape of the subject SB presented in the captured image, the class of the subject SB, and the relationship between the subject SB and the surrounding object PO.

The first calculation device 10 includes the rule database RD. The rule database RD defines an integration rule for integrating the two-dimensional positional relationship presented in the first image and the two-dimensional positional relationship presented in the second image into a three-dimensional positional relationship. The occlusion determination unit 11 detects all combinations of the captured images corresponding to the first image and the second image from the plurality of captured images having different image capturing directions. The occlusion determination unit 11 applies the integration rule to each combination of the captured images and estimates the three-dimensional positional relationship for each combination of the captured images. The occlusion determination unit 11 consolidates all the three-dimensional positional relationships obtained by the estimation, and determines the occlusion relationship based on the consolidated information obtained by the consolidation.

According to this configuration, the occlusion relationship between the subject SB and the surrounding object PO is obtained with high accuracy.

The occlusion determination unit 11 takes a majority decision on all the three-dimensional positional relationships obtained by the estimation. The occlusion determination unit 11 acquires a three-dimensional positional relationship obtained by majority decision, as consolidated information.

With this configuration, accurate information regarding the occlusion relationship can be obtained by simple calculation.

The search unit 14 extracts one or more registered objects RO whose positional relationship with the coexisting object CO matches the positional relationship between the subject SB and the surrounding object PO, as the object candidates CA. The search unit 14 detects the object candidate CA having the most similar shape to the subject SB among the extracted one or more object candidates CA as the registered object RO corresponding to the subject SB.

According to this configuration, after a simple search based on the positional relationship with the surrounding object PO, a detailed search based on the shape of the subject SB is performed. This reduces the search time and improves the accuracy of the search.

The model database MD defines a part of the registered object RO that can be located behind the coexisting object CO as an occluded part. The search unit 14 performs the similarity judgment between the subject SB and the object candidate CA by giving a higher weight to the feature of the object candidate CA of the portion excluding the occluded part than the occluded part. For example, the search unit 14 check whether the shape of the subject SB matches the shape of the object candidate CA of the portion excluding the occluded part to judge the similarity between the subject SB and the object candidate CA.

This configuration enhances the accuracy of the similarity judgment between the subject SB and the object candidate CA.

The effects described in the present specification are merely examples, and thus, there may be other effects, not limited to the exemplified effects.

### Supplementary Notes

Note that the present technique can also have the following configurations.

(1)

An information processing device comprising:
an occlusion determination unit that determines presence or absence of an occlusion relationship between a subject included in a captured image and a surrounding object existing around the subject;
a model database that defines a shape of a registered object; and
a missing completion processing unit that completes a shape of the subject at a portion hidden behind the surrounding object due to the occlusion relationship, by using the shape of the registered object.
   (2)

The information processing device according to (1), further comprising
a search unit that searches for the registered object corresponding to the subject, wherein
the model database defines a class of the registered object and a positional relationship between the registered object and a coexisting object that can coexist around the registered object, and
the search unit checks whether each of the shape of the subject, a class of the subject, and a positional relationship between the subject and the surrounding object matches the model database, and detects the registered object.
   (3)

The information processing device according to (2), further comprising
a rule database, the rule database defining an integration rule for integrating a two-dimensional positional relationship presented in a first image and a two-dimensional positional relationship presented in a second image into a three-dimensional positional relationship, wherein
the occlusion determination unit
detects all combinations of captured images corresponding to the first image and the second image from among a plurality of captured images having different image capturing directions,
applies the integration rule to each of the combinations of the captured images, and estimates the three-dimensional positional relationship for each of the combinations of the captured images, and
consolidates all three-dimensional positional relationships obtained by the estimation, and determines the occlusion relationship based on consolidated information obtained by the consolidation.
   (4)

The information processing device according to (3), wherein
the occlusion determination unit takes a majority decision on all the three-dimensional positional relationships obtained by the estimation, and acquires a three-dimensional positional relationship obtained by the majority decision, as the consolidated information.
   (5)

The information processing device according to any one of (2) to (4), wherein
the search unit extracts, as object candidates, one or more registered objects whose positional relationship with the coexisting objects matches the positional relationship between the subject and the surrounding objects, and detects an object candidate having a most similar shape to the subject among the one or more extracted object candidates, as the registered object corresponding to the subject.
   (6)

The information processing device according to (5), wherein
the model database defines a part of the registered object that can be hidden behind the coexisting object, as an occluded part, and
the search unit judges a similarity between the subject and the object candidate by weighting a feature of the object candidate in a portion excluding the occluded part with a higher weight than a weight on the occluded part.
   (7)

The information processing device according to (6), wherein
the search unit checks whether the shape of the subject matches the shape of the object candidate in the portion excluding the occluded part so as to judge a similarity between the subject and the object candidate.
   (8)

An information processing method executed by a computer,

the method comprising:
determining presence or absence of an occlusion relationship between a subject included in a captured image and a surrounding object existing around the subject; and
completing a shape of the subject in a portion hidden behind the surrounding object due to the occlusion relationship, by using a shape of a registered object defined in a model database.
   (9)

A computer-readable non-transitory storage medium storing a program that causes a computer to implement processing comprising:
determining presence or absence of an occlusion relationship between a subject included in a captured image and a surrounding object existing around the subject; and
completing a shape of the subject in a portion hidden behind the surrounding object due to the occlusion relationship, by using a shape of a registered object defined in a model database.

### REFERENCE SIGNS LIST

10 FIRST CALCULATION DEVICE (INFORMATION PROCESSING DEVICE)
11 OCCLUSION DETERMINATION UNIT
14 SEARCH UNIT
15 MISSING COMPLETION PROCESSING UNIT
CA OBJECT CANDIDATE
CO COEXISTING OBJECT
MD MODEL DATABASE
PO SURROUNDING OBJECT
RD RULE DATABASE
RO REGISTERED OBJECT
SB SUBJECT

1. An information processing device comprising:
an occlusion determination unit that determines presence or absence of an occlusion relationship between a subject included in a captured image and a surrounding object existing around the subject;
a model database that defines a shape of a registered object; and
a missing completion processing unit that completes a shape of the subject at a portion hidden behind the surrounding object due to the occlusion relationship, by using the shape of the registered object.

2. The information processing device according to claim 1, further comprising
a search unit that searches for the registered object corresponding to the subject, wherein
the model database defines a class of the registered object and a positional relationship between the registered object and a coexisting object that can coexist around the registered object, and
the search unit checks whether each of the shape of the subject, a class of the subject, and a positional relationship between the subject and the surrounding object matches the model database, and detects the registered object.

3. The information processing device according to claim 2, further comprising
a rule database, the rule database defining an integration rule for integrating a two-dimensional positional relationship presented in a first image and a two-dimensional positional relationship presented in a second image into a three-dimensional positional relationship, wherein
the occlusion determination unit
detects all combinations of captured images corresponding to the first image and the second image from among a plurality of captured images having different image capturing directions,
applies the integration rule to each of the combinations of the captured images, and estimates the three-dimensional positional relationship for each of the combinations of the captured images, and
consolidates all three-dimensional positional relationships obtained by the estimation, and determines the occlusion relationship based on consolidated information obtained by the consolidation.

4. The information processing device according to claim 3, wherein
the occlusion determination unit takes a majority decision on all the three-dimensional positional relationships obtained by the estimation, and acquires a three-dimensional positional relationship obtained by the majority decision, as the consolidated information.

5. The information processing device according to claim 2, wherein
the search unit extracts, as object candidates, one or more registered objects whose positional relationship with the coexisting objects matches the positional relationship between the subject and the surrounding objects, and detects an object candidate having a most similar shape to the subject among the one or more extracted object candidates, as the registered object corresponding to the subject.

6. The information processing device according to claim 5, wherein
the model database defines a part of the registered object that can be hidden behind the coexisting object, as an occluded part, and
the search unit judges a similarity between the subject and the object candidate by weighting a feature of the object candidate in a portion excluding the occluded part with a higher weight than a weight on the occluded part.

7. The information processing device according to claim 6, wherein
the search unit checks whether the shape of the subject matches the shape of the object candidate in the portion excluding the occluded part so as to judge a similarity between the subject and the object candidate.

8. An information processing method executed by a computer, the method comprising:
determining presence or absence of an occlusion relationship between a subject included in a captured image and a surrounding object existing around the subject; and
completing a shape of the subject in a portion hidden behind the surrounding object due to the occlusion relationship, by using a shape of a registered object defined in a model database.

9. A computer-readable non-transitory storage medium storing a program that causes a computer to implement processing comprising:
determining presence or absence of an occlusion relationship between a subject included in a captured image and a surrounding object existing around the subject; and
completing a shape of the subject in a portion hidden behind the surrounding object due to the occlusion relationship, by using a shape of a registered object defined in a model database.
